(19) United States
(12) Patent Application Publication
(10) Pub. No.: US 2023/0089513 A1
(43) Pub. Date: Mar. 23, 2023

(54) IMPROVEMENTS IN AND RELATING TO POWER SAVING IN A TELECOMMUNICATION NETWORK

(71) Applicant: Samsung Electronics Co., Ltd., Suwon-si, Gyeonggi-do (KR)

(72) Inventors: Shangbin WU, Staines Middlesex (GB); Yue WANG, Staines Middlesex (GB)

(21) Appl. No.: 17/909,178

(22) PCT Filed: Mar. 4, 2021
(86) PCT No.: PCT/KR2021/002663

§ 371 Date: Sep. 2, 2022

(30) Foreign Application Priority Data
Mar. 6, 2020 (GB) 2003299.1

(51) Int. Cl. H04W 52/02

(52) U.S. Cl. CPC H04W 52/0254; H04W 52/0212; H04W 52/0206

(57) ABSTRACT

The present disclosure relates to a pre-5^{th}-Generation (5G) or 5G communication system to be provided for supporting higher data rates Beyond 4^{th}-Generation (4G) communication system such as Long Term Evolution (LTE). Disclosed is a method of controlling the power consumption of a mobile telecommunication network, comprising the steps of: providing a power saving function and providing a positioning function, wherein the power saving function is operable to control at least one of load and the amount of available radio resources that are activated and power configurations of connected cells in the network and the positioning function is operable to acquire position information related to user equipments, UEs, connected to the cells.

### CROSS-REFERENCE TO RELATED APPLICATION(S)

This application is a U.S. National Stage application under 35 U.S.C. § 371 of an International application number PCT/KR2021/002663, filed on Mar. 4, 2021, which is based on and claims priority of a United Kingdom patent application number 2003299.1, filed on Mar. 6, 2020, in the United Kingdom Intellectual Property Office, the disclosure of which is incorporated by reference herein in its entirety.

### TECHNICAL FIELD

This invention relates to power consumption in a mobile telecommunication network.

### BACKGROUND ART

To meet the demand for wireless data traffic having increased since deployment of 4G (4^{th}-Generation) communication systems, efforts have been made to develop an improved 5G (5^{th}-Generation) or pre-5G communication system. Therefore, the 5G or pre-5G communication system is also called a ‘beyond 4G network’ or a ‘post LTE system’.

The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G communication systems.

In addition, in 5G communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like.

In the 5G system, hybrid FSK and QAM modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

It is predicted that the number of mobile broadband subscriptions will reach eight billion (8×10⁹) by the year 2025. New emerging applications such as augmented reality (AR), virtual reality (VR), vehicle to everything (V2X), and internet of things (IoT) are projected to lead to an ever-increasing contribution to the massive growth of data traffic. The fifth generation (5G) mobile network (MN) reduces cell size and increases cell density to enhance network throughput.

### DISCLOSURE OF INVENTION

### Technical Problem

Denser cells lead to larger MN power consumption, which increases greenhouse gas emissions, which in turn contribute to climate change. To tackle the problem of MN power consumption, new ways to manage MN power consumption are required.

### Solution to Problem

Embodiments of the present invention aim to address issues with power consumption in mobile networks, whether mentioned herein or not.

According to the present invention there is provided an apparatus and method as set forth in the appended claims. Other features of the invention will be apparent from the dependent claims, and the description which follows.

According to a first aspect of the present invention there is provided a method of controlling the power consumption of a mobile telecommunication network, comprising the steps of: providing a power saving function and providing a positioning function, wherein the power saving function is operable to control at least one of load and the amount of available radio resources that are activated and power configurations of connected cells in the network and the positioning function is operable to acquire position information related to user equipments, UEs, connected to the cells.

In an embodiment, the power saving function instructs each connected cell to report network state information to the power saving function.

In an embodiment, network state information comprises one or more of: a network traffic map; a user throughput map; and a cell load.

In an embodiment, each connected cell collects information from UEs attached thereto, the information comprising one or more of channel state information (CSI) and hybrid automatic repeat request (HARQ) information.

In an embodiment, each connected cell consults the positioning function to map user throughput in an area of interest.

In an embodiment, each connected cell compiles network state information and reports to the power saving function.

In an embodiment, the power saving function sends cell load control information to each connected cell to adjust its load and corresponding power consumption.

In an embodiment, the cell load control information indicates at least one of an operational load and the amount of available radio resources that are activated to each cell.

In an embodiment, the operational load is controlled by one or more of scaling up or down resources, including one or more of: the number of active Physical Resource Blocks; Modulation Coding Scheme levels; and the number of active antenna radio frequency chains, and transmission power.

In an embodiment, one or more of the power saving function and positioning function is virtualised and/or centralised.

In an embodiment, the power saving function comprises an Artificial Intelligence module which incorporates a deep convolutional neural network.

In an embodiment, the power saving function receives network state information and aggregates the network state information into a two-dimensional image and a one-dimensional vector, wherein a first channel of the two-dimensional image is the aggregated throughput map, recording the throughput of cells in the area of interest; a second channel of the two-dimensional image is the aggregated traffic map, recording the traffic of cells in the area of interest; and the one-dimensional vector records the loads of cells in the area of interest.

In an embodiment, DCNN Q-learning is utilised as a learning architecture of the power saving function.

In an embodiment, the positioning function utilises mobile-network assisted positioning or GNSS positioning.

According to a second aspect of the present invention there is provided mobile network comprising a power saving functional unit and a positioning functional unit operable to perform the method of the first aspect.

Embodiments of the invention implement a scheme which includes separating the positioning function and function from the existing network architecture. The power saving function is equipped with an artificial intelligence module, which performs reinforcement learning to optimize cell loads (i.e. amount of available radio resources) and power. New signalling procedures, such as network state information and capability information, are provided in embodiments of the invention.

Embodiments further provide a new network architecture, as well as smart resource management techniques.

Embodiments of the invention offer significant savings in power consumption, compared to prior art network. Savings in the region of 20% are achieved.

Although a few preferred embodiments of the present invention have been shown and described, it will be appreciated by those skilled in the art that various changes and modifications might be made without departing from the scope of the invention, as defined in the appended claims.

### Advantageous Effects of Invention

The present invention provides a way to manage power consumption efficiently in a mobile telecommunication network.

### BRIEF DESCRIPTION OF DRAWINGS

For a better understanding of the invention, and to show how embodiments of the same may be carried into effect, reference will now be made, by way of example only, to the accompanying diagrammatic drawings in which:

FIG. 1 shows a general overview of a mobile network according to an embodiment of the invention;

FIG. 2 shows a signalling procedure according to an embodiment of the invention;

FIG. 3 shows a block diagram of a power saving function according to an embodiment of the invention;

FIG. 4 shows a block diagram of a deep convolutional neural network according to an embodiment of the invention;

FIG. 5 shows an illustration of capability information utilised in an embodiment of the invention;

FIG. 6 shows an illustration of network state information utilised in an embodiment of the invention;

FIG. 7 shows a mobile network-assisted positioning function according to an embodiment of the invention;

FIG. 8 shows a GNSS-assisted positioning function according to an embodiment of the invention; and

FIG. 9 shows an illustration of a connection between the positioning function and the serving cell via different interfaces.

### MODE FOR THE INVENTION

The power consumption of a mobile network according to an embodiment of the invention is controlled by a power saving function, which accesses geographical information, e.g., throughput in the area of interest and/or traffic in the area of interest, via a positioning function. Both the power saving function and the positioning function are logical entities, which can be virtualized or embedded in certain physical units.

Depending on the level of centralization, one instance of power saving function and one instance of positioning function are able to control the entire network in a fully centralized manner. On the contrary, however, multiple instances of power saving function and positioning function can be created, each controlling part of the network, in a distributed manner.

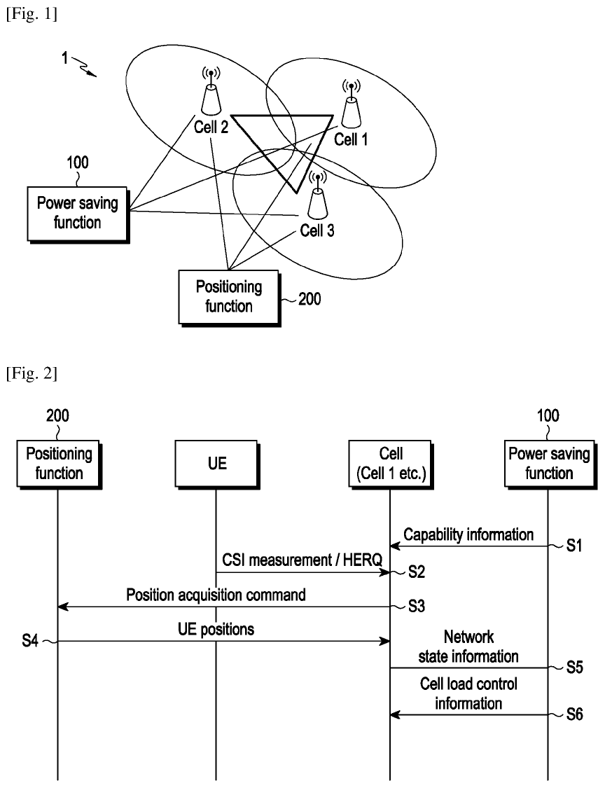

FIG. 1 shows a general overview of a mobile network according to an embodiment of the invention.

FIG. 1 illustrates a mobile network 1, comprising a number of cell sites (Cell 1-Cell 3) with an additional power saving function 100 and an additional positioning function 200. Each cell is connected to both functions 100, 200. The power saving function 100 is responsible for controlling the load and power configurations of cells.

The positioning function 200 is responsible for acquiring positions of user equipments (UEs, not shown). Both the power saving function 100 and the positioning function 200 are logical entities, which can be virtualized or embedded in certain physical units. The power saving function is implemented using Artificial Intelligence (AI) based approaches, such as reinforcement learning.

The power saving function 100 transmits a message signalling its capability information to cells. Each cell forms a message, containing network state information (NSI), after obtaining UE positions in the positioning function 200 and feeds back to the power saving function 100.

Then, the power saving function 100 transmits a message to each cell indicating the cell load control information. This procedure is illustrated in FIG. 2.

FIG. 2 shows a signalling procedure according to an embodiment of the invention.

First, at step S1, a message named “capability information” is sent from the power saving function 100 to each cell. The capability information contains instructions on what and how to report NSI, i.e., traffic of the cell, reporting period, window size when calculating throughput, geographical resolution, etc.

Upon receiving the capability information message, each cell starts collecting measurement from its attached UEs at step S2. The information to be collected includes channel state information (CSI) and hybrid automatic repeat request (HARQ) information, which can be used to derive user throughputs.

Moreover, each cell, at step S3, consults the positioning function 200 to map user throughputs to throughputs in locations in the Area of Interest (AOI) based on the geographical resolution in the capability information. This information is provided at step S4.

Next, at step S5, each cell forms a NSI message, containing a network traffic map, a network throughput map, and the current cell load, and sends the NSI message to the power saving function 100.

Lastly, at step S6, the power saving function 100 sends cell load control information to each cell to adjust their loads and corresponding power consumptions.

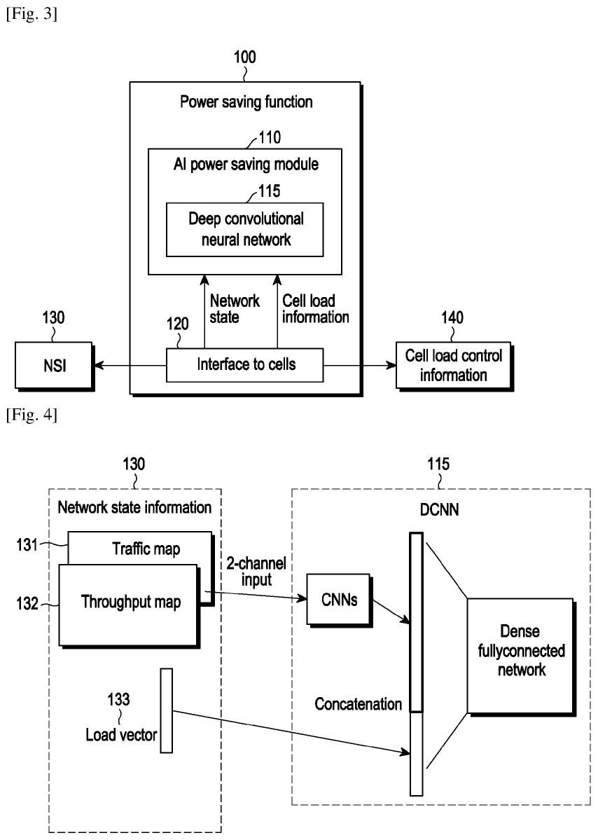

FIG. 3 shows a block diagram of a power saving function according to an embodiment of the invention and FIG. 4 shows a block diagram of a deep convolutional neural network according to an embodiment of the invention.

FIG. 3 illustrates the power saving function 100. The power saving function 100 is a virtualized function, including an artificial intelligence power saving module 110 and an interface to cells 120.

The interface to cells 120 is responsible for converting NSI 130 to a format that is acceptable for the AI power saving module 110 and converting the output of the deep convolutional neural network (DCNN) 115 to a format that is acceptable for each cell.

An example of the DCNN 115 structure is shown in FIG. 4. After the interface to cells 120 aggregates the NSI 130 into a two-channel two-dimensional image and a one-dimensional vector, the formatted network state is input to the DCNN 115. One channel of the image is the aggregated throughput map 131, recording the throughput of cells in the AOI. The other channel of the image is the aggregated traffic map 132, recording the traffic of cells in the AOI. The one-dimensional vector 133 is recording the loads of cells in the AOI.

Embodiments of the invention use the DCNN Q-learning architecture as the intelligence of the power saving function. Other Machine Learning techniques may be utilised, as required. For instance, other CNN techniques, such as recurrent CNN may be utilised. This DCNN Q-learning problem can be divided into the design of state space, action space, policy, reward function, and action-state function (Q function).

In more detail, these are:

State space: a state, characterized by the NSI, capable of capturing what the current requirement of network traffic volume (NTV) is and how well the system is responding to such requirement. Therefore, it should include current cell loads, a traffic map, and a throughput map.

Action space: an action, characterized by the cell load information, is to tune cell loads.

Policy: a mapping, characterized by the interface to cells, should map a state to a final cell load control information. Certain policies, such as the widely-used ε-greedy algorithm, allow that the final cell load control information differs from the action.

Reward function: a negative reward is applied if the current network throughput is not able to satisfy the NTV requirement. The current network throughput and the NTV requirement are derived from the NSI. The value of negative reward is customizable by the network operator and controlled via the operations and maintenance (O&M) interface of the network. If the current network throughput is able to satisfy the NTV requirement, the reward is monotonically increasing if the network consumes less power. The form of the reward is also customizable by the network operator.

Q function: the Q function records the accumulated reward of a state-action pair. This is characterized by the DCNN in the power saving function.

The weights in the network will be trained and updated each time a NSI is fed back. The output of the DCNN is the action (adjusted cell loads) with the highest Q value.

A message (capability information) is sent at step S1 from the power saving function 100 to a cell. This message is to inform a cell what the interface of the artificial intelligence module is in the power saving function. A new capability information message can be sent to re-configure the setting.

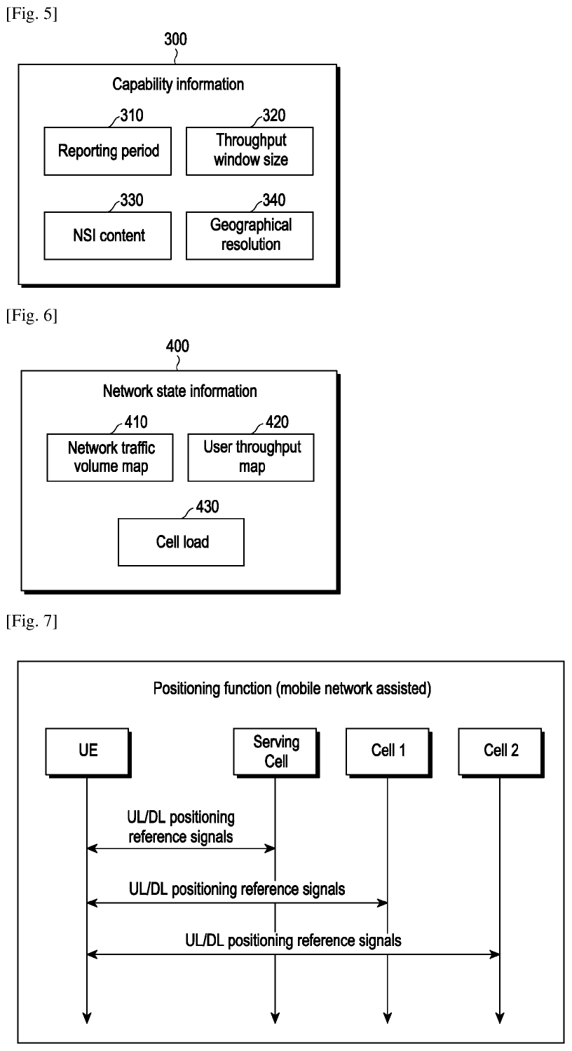

FIG. 5 shows an illustration of capability information utilised in an embodiment of the invention.

FIG. 5 illustrates the content inside the capability information message 300. It consists of the reporting period 310, throughput window size 320, NSI content 330, and geographical resolution 340. The reporting period 310 configures the period of the NSI feedback. Also, an aperiodic report can configured via the capability information 300. The throughput window size 320 is the size of the observing window of throughput calculation. The configuration of NSI content 330 indicates what needs to be reported, e.g. throughput map 132 in the AOI, and traffic map 131 in the AOI. For geographical resolution 340, a cell can quantize the throughput map 132 and traffic map 131 according to this resolution to minimize complexity and feedback overhead.

FIG. 6 shows an illustration of network state information utilised in an embodiment of the invention.

FIG. 6 illustrates the content inside the network state information message 400. Network state information 400 is a message sent from a cell to the power saving function 100, describing the current state of the cell. The content inside includes a throughput map 420 describing the throughput of the cell in the AOI, a traffic map 410 describing the traffic of the cell in the AOI, and the current cell load 430. Depending on the level of centralization, a message of network state information 400 can include the information of the whole network in a fully centralized manner or the information of part of the network in a distributed manner. The reporting of the NSI 400 is periodic, but it can also be reported aperiodically if the power saving function 100 initiates an aperiodic NSI report command. The capability information 300 can determine what NSI content to be embedded in the NSI message 400. It can be the throughput map 420 only, the traffic map 410 only, the current cell load 430 only, or two of these, or all three of them. The configuration of NSI content can make use of different coherence time of those three types of contents.

Cell load control information is a message sent at S6 from the power saving function 100 to each cell, configuring the load of a cell. The cell load control information indicates how much load a particular cell should be operating at or the amount of available radio resources that can be activated. It contains factors scaling up or down resources, such as scaling up/down the number of active Physical Resource Blocks (PRBS), Modulation Coding Scheme (MCS) levels, number of active antenna radio frequency (RF) chains, transmission power etc.

The positioning function 200 is a virtualized function, which includes procedures to allow a serving cell to obtain UE positions.

The positioning can be performed in a mobile network assisted manner or a global navigation satellite system (GNSS) e.g. GPS assisted manner. The mobile network assisted positioning can be achieved using positioning reference signals as provided in 4G and 5G systems.

FIG. 7 shows a mobile network-assisted positioning function according to an embodiment of the invention.

FIG. 7 illustrates a procedure for mobile network assisted positioning.

A UE is transmitting/receiving positioning reference signals from/to multiple cells. Cells are connected to the serving cell and pass information about the measurement of power level/time/angle/space/delay/etc of the target UE to the serving cell. Then, the serving cell aggregates the information and estimates the location of the UE in the AOI.

In addition, the GNSS assisted positioning can be achieved using GNSS (e.g. GPS) signal.

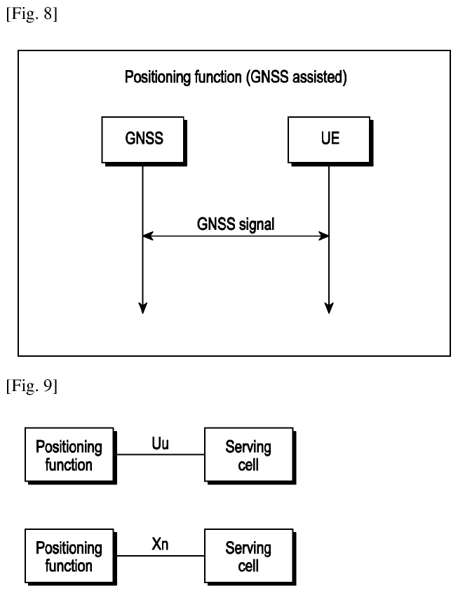

FIG. 8 shows a GNSS-assisted positioning function according to an embodiment of the invention and FIG. 9 shows an illustration of a connection between the positioning function and the serving cell via different interfaces.

FIG. 8 illustrates the procedure of GNSS assisted positioning. A UE receives the GNSS signal and estimates its location. When the location is estimated, it is then sent to the serving cell.

It is observed that a target UE will generally be connected to the positioning function wirelessly, via either a 4G/5G mobile network or GNSS. However, it is possible for the serving cell to connect to the positioning function using both the radio interface between the mobile and the radio access network (Uu) and the interface between base stations (Xn), as shown in FIG. 9. When the Uu interface is used, the serving cell is behaving as a terminal, and the positioning function transmits the location of a UE to the serving cell using a downlink shared channel. When the Xn interface is used, the serving cell is behaving as a base station and the positioning function is passing the information of the location of a UE to the serving cell in a network coordination manner.

Embodiments of the invention provide an improved architecture which provides improved power saving. Further, embodiments of the invention adopt the use of AI techniques and procedures to improve performance over prior art systems.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of controlling power consumption by a mobile network entity in a mobile telecommunication network, the method comprising:
providing a power saving function to control at least one of load and an amount of available radio resources that are activated and power configurations of connected cells in the mobile telecommunication network; and
providing a positioning function to acquire position information related to user equipments, UEs, connected to the cells in the mobile telecommunication network.

2. The method of claim 1, wherein the power saving function instructs each connected cell to report network state information to the power saving function.

3. The method of claim 2, wherein network state information comprises one or more of:
a network traffic map,
a user throughput map, and
a cell load.

4. The method of claim 2, wherein each connected cell collects information from UEs, the information comprising one or more of channel state information (CSI) and hybrid automatic repeat request (HARQ) information.

5. The method of claim 4, wherein each connected cell consults the positioning function to map user throughput in an area of interest.

6. The method of claim 5, wherein each connected cell compiles network state information and reports to the power saving function.

7. The method of claim 6, wherein the power saving function sends cell load control information to each connected cell to adjust its load and corresponding power consumption.

8. The method of claim 7, wherein the cell load control information indicates at least one of an operational load and the amount of available radio resources that are activated to each cell.

9. The method of claim 8,
wherein the operational load is controlled by one or more of scaling up or down resources, and
wherein the cell load control information includes one or more of:
a number of active Physical Resource Blocks,
Modulation Coding Scheme levels, and
a number of active antenna radio frequency chains, and transmission power.

10. The method of claim 1, wherein one or more of the power saving function and positioning function is virtualized or centralized.

11. The method of claim 1, wherein the power saving function comprises an Artificial Intelligence module which incorporates a deep convolutional neural network.

12. The method of claim 11,
wherein the power saving function receives network state information and aggregates the network state information into a two-dimensional image and a one-dimensional vector, and
wherein a first channel of the two-dimensional image is an aggregated throughput map, recording a throughput of cells in an area of interest; a second channel of the two-dimensional image is an aggregated traffic map, recording a traffic of cells in the area of interest; and the one-dimensional vector records loads of cells in the area of interest.

13. The method of claim 10, where DCNN Q-learning is utilized as a learning architecture of the power saving function.

14. The method of claim 1, wherein the positioning function utilizes mobile-network assisted positioning or GNSS positioning.

15. A mobile network entity in a mobile telecommunication network, the mobile network entity comprising:
a transceiver;
a power saving functional unit configured to control at least one of load and amount of available radio resources that are activated and power configurations of connected cells in the mobile telecommunication network; and
a positioning functional unit configured to acquire position information related to user equipments, (UEs) connected to the cells in the mobile telecommunication network.

16. The mobile network entity of claim 15, wherein the power saving functional unit is configured to:
instruct each connected cell to report network state information to the power saving functional unit.

17. The mobile network entity of claim 16, wherein network state information comprises one or more of:
a network traffic map,
a user throughput map, and
a cell load.

18. The mobile network entity of claim 16, wherein each connected cell collects information from UEs, the information comprising one or more of channel state information (CSI) and hybrid automatic repeat request (HARQ) information.

19. The mobile network entity of claim 18, wherein each connected cell consults the positioning function to map user throughput in an area of interest.

20. The mobile network entity of claim 19, wherein each connected cell compiles network state information and reports to the power saving function.
